(19) United States
(12) Patent Application Publication
(10) Pub. No.: US 2024/0351484 A1
(43) Pub. Date: Oct. 24, 2024

(54) ROTATION ANGLE SENSING SYSTEM AND METHOD OF SWIVEL CORE

(71) Applicant: DAEWONSANUP CO., LTD., Ansan-si (KR)

(72) Inventors: Hyuk KIM, Ansan-si (KR); Sang Yong KOO, Incheon (KR); Joo Hyun CHO, Ansan-si (KR)

(21) Appl. No.: 18/638,118

(22) Filed: Apr. 17, 2024

(30) Foreign Application Priority Data
Apr. 18, 2023 (KR) 10-2023-0050859

(51) Int. Cl. B60N 2/02; B60N 2/07; B60N 2/14; G01D 5/04; G01D 18/00

(52) U.S. Cl. CPC B60N 2/0272; B60N 2/02246; B60N 2/07; B60N 2/146; G01D 5/04; G01D 18/001; G01D 2205/20; G01D 2205/776

(57) ABSTRACT

The present disclosure relates to a rotation angle sensing system and method of swivel core that enables recognition of an accurate standard position of a rotor, may include a rotation sensing device installed on a stator of the swivel core and sensing rotation state of a rotor of the swivel core; and an identifier formed on the rotor to generate a sensing signal of the rotation sensing device, wherein the standard position of the rotor can be calibrated or initialized by only one rotation sensing device, thereby decreasing the number of sensors to be installed, reducing installation cost or manufacturing cost and accurately sense a standard position by forming a hill part as an identifier on the inner surface of the rotor.

### CROSS-REFERENCE TO RELATED APPLICATION(S)

This application is based on and claims priority of Korean Patent Application No. 10-2023-0050859, filed on Apr. 18, 2023, with the Korean Intellectual Property Office, the entire contents of which are hereby incorporated by reference.

### STATEMENT REGARDING SPONSORED RESEARCH OR DEVELOPMENT

The research and development of the invention of the present application was conducted with research project support from the “World Class Plus Program” of the South Korean Ministry of Trade, Industry, and Energy and the Korea Institute for Advancement of Technology. The title of this research project is “Establishment of the Base for Autonomous Vehicle Test Driving-Based Electric/Electronic Parts and Materials” (Project Number: P0021941, Detailed Project Identifier: 0021941C, Research Period: Jun. 1, 2022-Dec. 31, 2025, Supervising Company: Daewonsanup Co., Ltd.).

### TECHNICAL FIELD

The present disclosure relates to a rotation angle sensing system and method of swivel core, and more particularly to a rotation angle sensing system and method of swivel core that enables recognition of an accurate standard position of a rotor.

### BACKGROUND

In general, a swivel core applied to a swivel seat of a vehicle, etc. has a relatively long distance or angle of rotation stroke, so if limit switches are installed at the beginning and end of a conventional stroke, the initial setting time is long, and at least two limit switches are required, so there were many problems, such as increasing installation cost or manufacturing cost.

In particular, the swivel core applied to a swivel seat of a conventional vehicle can be rotated infinitely, so there is no stopper or reference structure, etc. to physically stop the rotation. Therefore, there were problems, such as difficulty of accurately sensing rotation angle and controlling rotation position.

In addition, when the swivel core was repeatedly rotated forward or backward multiple times, there were many problems such as errors accumulating with each rotation, gradually causing the position to be significantly misaligned, resulting in a malfunction.

### SUMMARY

The present disclosure is intended to solve several problems including the above-mentioned problems. The present disclosure also aims to provide a rotation angle sensing system and method of swivel core, wherein the standard position of the rotor can be calibrated or initialized by only one rotation sensing device, thereby decreasing the number of sensors to be installed, reducing the installation cost or manufacturing cost. Furthermore, it is intended to provide the rotation angle sensing system and method of swivel core that can accurately sense the standard position by forming a hill part as an identifier on an inner surface of the rotor, thereby enabling accurate control of the rotation position. Also, it aims to provide the rotation angle sensing system and method of swivel core to prevent error accumulation or a malfunction phenomenon by calibrating or initializing the standard position of the rotor at initial installation or when necessary. However, these problems are exemplary and do not limit the scope of the present disclosure.

According to an aspect of the present disclosure, a rotation angle sensing system of a swivel core may comprise a rotation sensing device installed on a stator of the swivel core and sensing rotation state of a rotor of the swivel core; and an identifier formed on the rotor to generate a sensing signal of the rotation sensing device.

Further, according to the present disclosure, the rotation sensing device may be a contact sensor sensing contact with the identifier, and the identifier may be a hill part formed to protrude from an inner surface of the rotor.

Further, according to the present disclosure, said the contact sensor may comprise a switch body; a button part installed to be able to move forward and backward in the direction from the switch body to the identifier; and a switch circuit part installed at the switch body and generating an ON signal when the button part is pressed by the identifier.

Further, according to the present disclosure, the hill part may comprise an uphill portion formed from a starting point, where contact with the button part begins, to a highest point; and a downhill portion formed from the highest point to an end point, where contact with the button part ends.

Further, according to the present disclosure, a contact slope of the uphill portion and the downhill portion may be a gently curved surface.

Further, according to the present disclosure, the system may further comprise a fixing bracket which is fixed to one side of the stator and where the rotation sensing device is installed; a solenoid locking device installed at the fixing bracket to enable accurate locking by the sensing signal of the rotation sensing device and moving forward a locking protrusion to be combined with an inner groove formed at the rotor when the rotor is locking; and a control part receiving the sensing signal from the rotation sensing device, calibrating a standard position by using the sensing signal, transmitting a motor control signal driving a swivel motor to rotate the rotor of the swivel core based on the standard position, and transmitting a locking control signal to the solenoid locking device before or after applying the motor control signal.

Further, according to the present disclosure, the control part may be installed on any of a vehicle seat being transported along a S-shaped long slide, a vehicle seat being transported along a closed curved long slide, and a vehicle seat being transported along a U-shaped long slide to rotate the rotor in a direction that compensates for the rotation angle of the vehicle seat naturally swiveling while traveling along a curved rail.

On the other hand, according to an aspect of the present disclosure, a rotation angle sensing method of a swivel core may comprise a step (a) driving a swivel motor to rotate a rotor relative to a stator of the swivel core; a step (b) generating a sensing signal with a rotation sensing device installed on the stator by sensing an identifier installed on the rotor at least once; a step (c) calibrating a standard position of the rotor using the sensing signal; a step (d) driving the swivel motor to rotate the rotor to a desired angle based on the calibrated standard position of the rotor.

Further, according to the present disclosure, wherein in the step (c), the standard position is calculated by counting hall IC signals of the swivel motor.

Further, according to the present disclosure, the system may further comprise prior to the step (a), a step (e) initializing settings by driving the swivel motor to rotate the rotor forward at an angle of at least 180 degrees relative to the stator of the swivel core until the rotation sensing device senses the identifier or rotate the rotor backward at an angle of at least 180 degrees, and setting an initialization position of the rotor when the rotation sensing device senses the identifier.

According to some embodiments of the present disclosure as described above, it is possible to calibrate or initialize the standard position of the rotor with only one rotation sensing device, thereby decreasing the number of sensors to be installed, reducing the installation cost or manufacturing cost. It is also possible to sense the standard position accurately by forming a hill part as an identifier on the inner surface of the rotor, enabling accurate control of the rotation position. Furthermore, it can prevent error accumulation or malfunction phenomenon by calibrating or initializing the standard position of the rotor at least at the time of initial installation or when necessary. However, the scope of the present disclosure is not limited by these effects.

### BRIEF DESCRIPTION OF DRAWINGS

FIG. 1 is an exterior perspective view illustrating a rotation angle sensing system for a swivel core according to some embodiments of the present disclosure.

FIG. 2 is a part exploded perspective view of the rotation angle sensing system of the swivel core of FIG. 1.

FIG. 3 is a top plan view of the rotation angle sensing system of the swivel core of FIG. 1.

FIG. 4 is a cross-sectional view taken along a line A-A of the rotation angle sensing system of the swivel core of FIG. 3.

FIGS. 5 to 9 are drawings illustrating the rotation sensing device of the rotation angle sensing system of the swivel core of FIG. 1.

FIGS. 10A to 12B are drawings illustrating long slides with the rotation angle sensing system of the swivel core of FIG. 1.

FIG. 13 is a flowchart showing a rotation angle sensing method of the swivel core according to some embodiments of the present disclosure.

FIG. 14 is a flowchart illustrating a rotation angle sensing method of the swivel core according to some other embodiments of the present disclosure.

FIG. 15 is a flowchart illustrating a rotation angle sensing method of the swivel core in accordance with some other embodiments of the present disclosure.

### DETAILED DESCRIPTION OF EXEMPLARY EMBODIMENTS

Hereinafter, the present disclosure will be described in detail by explaining embodiments of the present disclosure with reference to the attached drawings.

Various embodiments of the present disclosure may be embodied in many different forms and should not be construed as being limited to the example embodiments set forth herein. Rather, these example embodiments of the disclosure are provided so that this disclosure will be thorough and complete and will convey inventive concepts of the disclosure to those skilled in the art. Also, in the drawings, the thicknesses or sizes of layers are exaggerated for clarity.

The terminology used herein is for the purpose of describing particular embodiments only and is not intended to be limiting of the disclosure. As used herein, the singular forms are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described herein with reference to schematic illustrations of idealized embodiments (and intermediate structures) of the disclosure. As such, variations from the shapes of the illustrations as a result, for example, of manufacturing techniques and/or tolerances, are to be expected. Thus, the embodiments of the present disclosure should not be construed as limited to the particular shapes of regions illustrated herein, but are to include deviations in shapes that result, for example, from manufacturing.

Hereinafter, the rotation angle sensing system of the swivel core in accordance with various embodiments of the present disclosure will be described in detail with reference to the drawings.

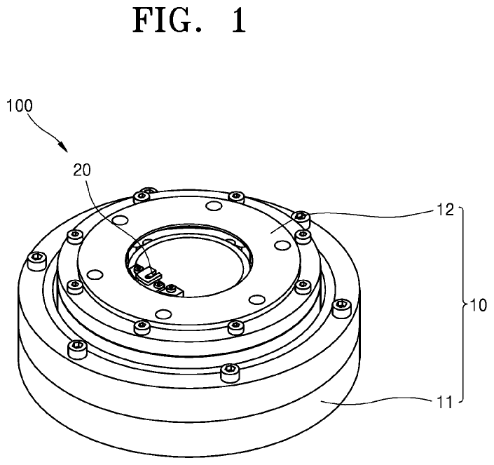

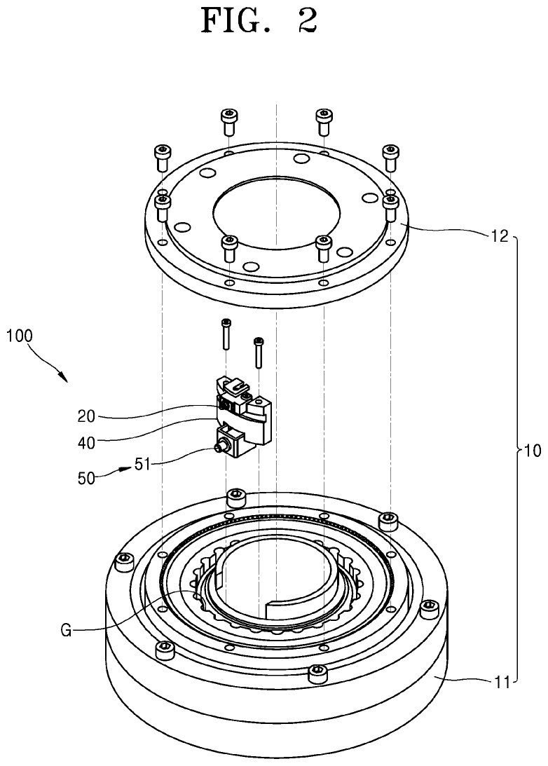

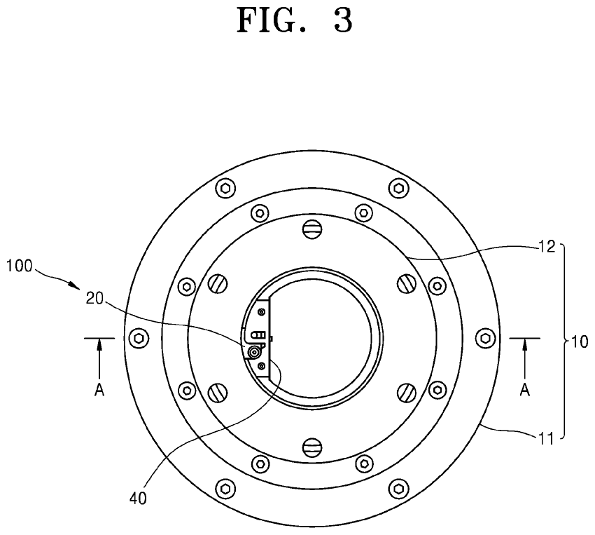

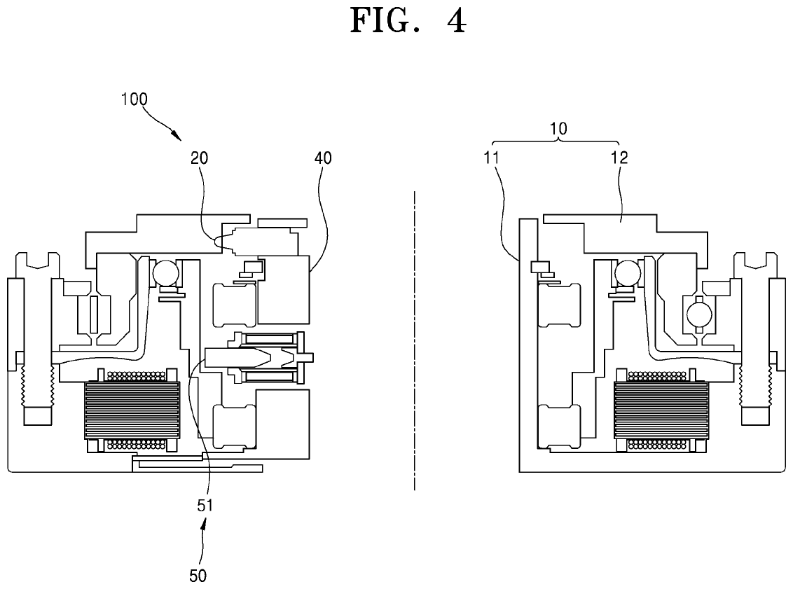

FIG. 1 is an exterior perspective view illustrating the rotation angle sensing system of the swivel core 100 according to some embodiments of the present disclosure, FIG. 2 is a part exploded perspective view of the rotation angle sensing system of the swivel core 100 of FIG. 1, FIG. 3 is a top plan view of the rotation angle sensing system of the swivel core 100 of FIG. 1, and FIG. 4 is a cross-sectional view taken along a line A-A of the rotation angle sensing system of the swivel core 100 of FIG. 3.

First, as shown in FIGS. 1 to 4, the rotation angle sensing system of the swivel core 100 according to some embodiments of the present disclosure is applied to the swivel core 10 and may include a rotation sensing device 20 and an identifier 30.

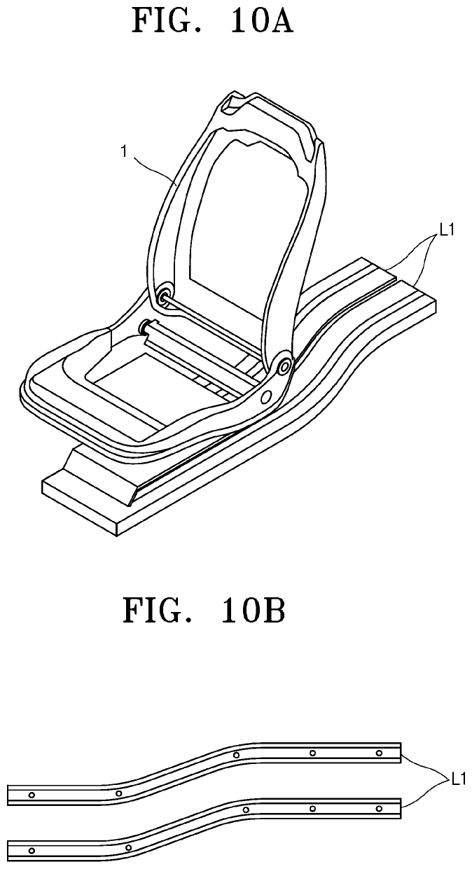

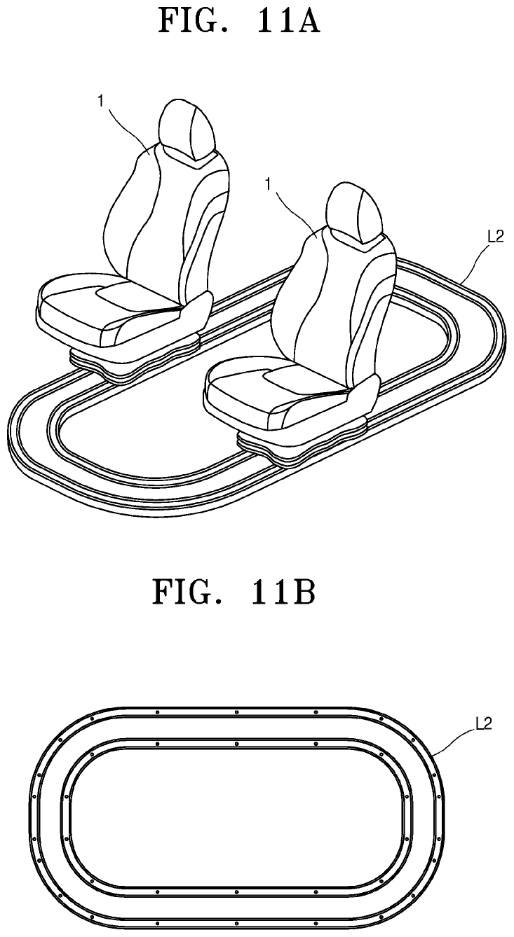

For example, the rotation sensing device 20 is installed at the stator 11 of the hollow swivel core 10 installed in a vehicle seat (1, see FIGS. 10A to 12B), etc., and may be a device that senses the rotation state of the swivel core 10 and the rotor 12.

Also, for example, an identifier 30 may be an identifiable part or component formed at the rotor 12 of the hollow swivel core 10 to cause a sensing signal of the rotation sensing device 20.

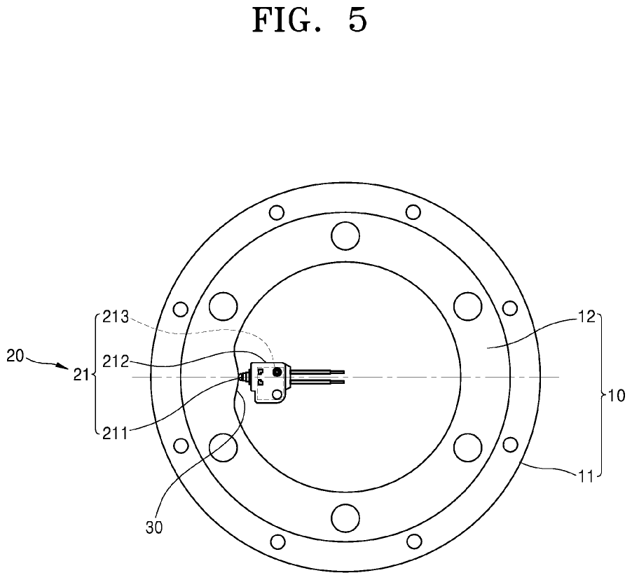

FIGS. 5 to 9 are drawings illustrating the rotation sensing device 20 of the rotation angle sensing system of the swivel core 100 of FIG. 1.

For example, the rotation sensing device 20 may be a contact sensor 21 that senses physical contact with the identifier 30, and the identifier 30 may be a hill part 31 formed on an inner surface of the rotor 12 protruding in the direction of the contact sensor 21.

More specifically, for example, the contact sensor 21 may include a switch body 211, a button part 212 installed to be able to move forward and backward in the direction from the switch body 211 to the identifier 30, and a switch circuit part 213 installed at the switch body 211 and generating an ON signal when the button part 212 is pressed by the identifier 30.

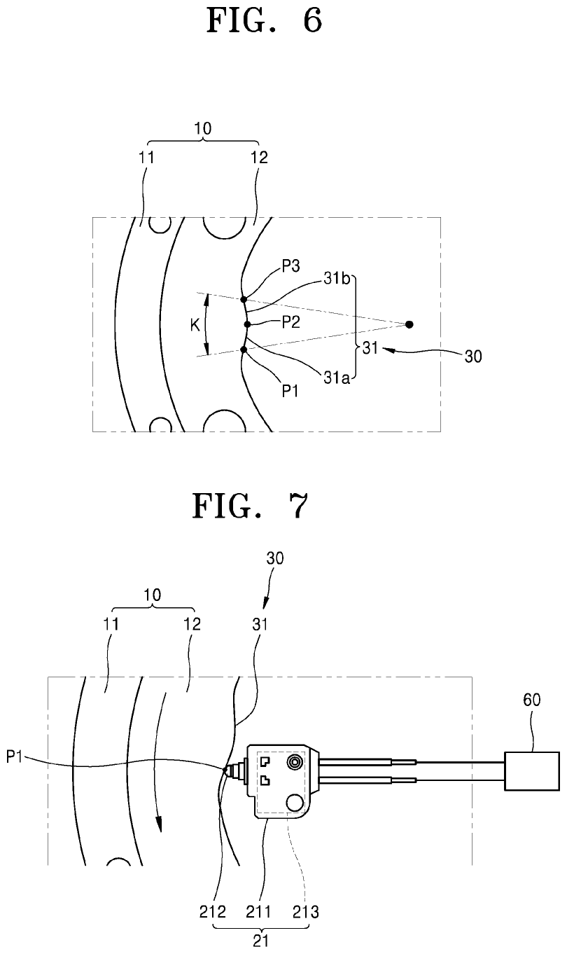

As shown in FIG. 6, the hill part 31 may include an uphill portion 31a formed from a starting point P1, where contact with the button part 212 begins, to a highest point P2 and a downhill portion 31b formed from the highest point P2 to an end point P3, where contact with the button part 212 ends.

Here, the starting point P1 to the end point P3 can be referred to as an identification angle (K) of the contact sensor 21, and the exact position can be sensed or recognized by calculation in many different ways, such as recognizing the position of the highest point P2 as a standard position, or recognizing the half position of the starting point P1 and the end point P3 as the standard position.

Also, for example, a contact slope of the uphill portion 31a and the downhill portion 31b may be a gently curved surface to minimize contact friction with the hill part 31 and the button part 212.

The uphill portion 31a and the downhill portion 31b may minimize contact friction by applying lubricants such as lubricating oil or grease, or installing rolling wheels (not shown in drawings) on the button part 212, etc.

The contact sensor 21, which utilizes physical contact with the identifier 30 to sense the position of the identifier 30, may have a switch circuit part 213 formed inside the contact sensor 21 such that it generates an OFF signal when not in contact with the identifier 30 and generates an ON signal when in contact with identifier 30.

Further, the switch circuit part 213 may be electrically connected with a control part (60, see FIGS. 7 to 9) which will be described later, to transmit the generated sensing signal to the control part 60.

However, this rotation sensing device 20 is not necessarily limited to the contact sensor 21, for example, any type of contact or non-contact sensor, such as a contact switch, magnetic sensor, light sensor, laser sensor, infrared sensor, etc. can be applied. Any type of identifier apart from the hill part 31, such as an identification magnet, an identification magnetizer, an identification projection, an identification step, an identification hole, an identification plate, an identification bracket, or an identification light blocker may be applied as the identifier 30.

As shown in FIGS. 1 to 9, the rotation angle sensing system of the swivel core 100 according to some embodiments of the present disclosure may include a fixing bracket 40 which is fixed to one side of the stator 11 and where a rotation sensing device 20 is installed, a solenoid locking device 50 installed at the fixing bracket 40 to enable accurate locking by the sensing signal of the rotation sensing device 20 and moving forward a locking protrusion 51 to be combined with an inner groove G formed at the rotor 12 when the rotor 12 is locking. The rotation angle sensing system of the swivel core 100 may further include the control part 60 receiving the sensing signal from the rotation sensing device 20, calibrating the standard position by using the sensing signal, transmitting a motor control signal driving a swivel motor M to rotate the rotor 12 of the swivel core 10 based on the standard position, and transmitting a locking control signal to the solenoid locking device 50 before or after applying the motor control signal.

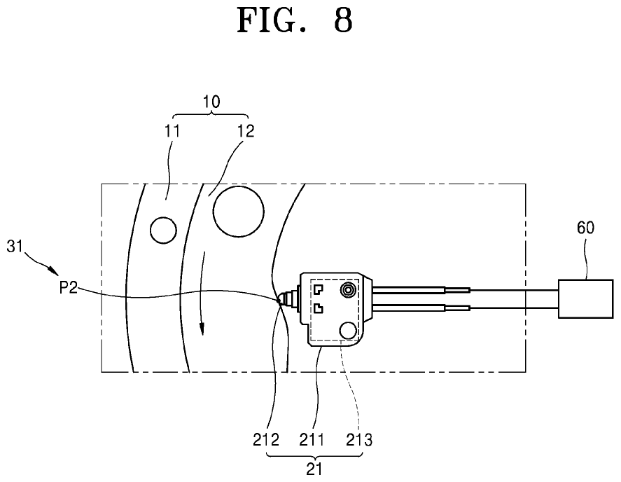

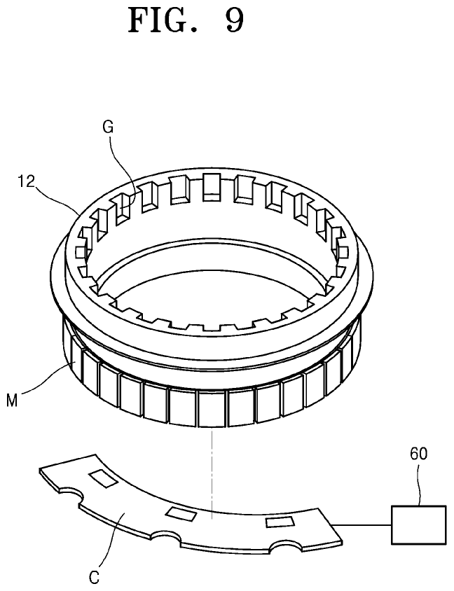

The operation process of the rotation angle sensing system of the swivel core 100 according to some embodiments of the present disclosure will be described hereinafter with reference to FIGS. 1 to 8. First, as shown in FIG. 7, the swivel motor (M, see FIG. 9) is driven to rotate the rotor 12 relative to the stator 11 of the swivel core 10. As a result, the rotation sensing device 20 installed in the stator 11 contacts the uphill portion 31a of the identifier 30 installed in the rotor 12, generating the sensing signal. As shown in FIG. 8, the rotation sensing device 20 may generate the sensing signal until it passes the downhill portion 31b.

At this time, the control part 60 may sense or recognize by calculation the exact position with a variety of methods, such as recognizing the position of the highest point (P2, see FIG. 6) as the standard position, or recognizing the half position between the starting point (P1, see FIG. 6) and the end point (P3, see FIG. 6) as the standard position.

Subsequently, the control part 60 may accurately calibrate and recognize the standard position of the rotor 12 even if the rotation error is accumulated using the sensing signal, and drive the swivel motor M based on the calibrated standard position of the rotor 12 to rotate the rotor 12 to the desired angle.

Here, the standard position of the rotor 12 may be calculated by counting a hall IC signal using a hall IC signal counter part C of the swivel motor M.

It is also possible to initialize the settings at the time of initial setup or initial operation, by test-running the swivel motor M to rotate the rotor 12 forward at an angle of at least 180 degrees relative to the stator 11 of swivel core 10 until the rotation sensing device 20 senses the identifier 30 or rotate the rotor 12 backward at an angle of at least 180 degrees, and setting an initialization position of the rotor 12 when the rotation sensing device 20 senses the identifier 30.

Since the standard position of the rotor 12 can be calibrated or initialized by only one rotation sensing device 20, it is possible to reduce the number of installations of sensors to lower the installation cost or manufacturing cost. In addition, the standard position may be accurately sensed by forming the hill part 31 as the identifier 30 on the inner surface of the rotor 12, thereby accurately controlling the rotation position, and the error accumulation or malfunction phenomenon may be prevented by calibrating or initializing the standard position of the rotor 12 at the time of initial installation or when necessary.

FIGS. 10A to 12B are drawings illustrating long slides (L1, L2, and L3) to which the rotation angle sensing system of the swivel core 100 of FIG. 1 may be applied.

As shown in FIGS. 10A and 10B, the control part 60 may be installed on a vehicle seat 1 being transported along an S-shaped long slide L1 to compensate for the rotation angle of the vehicle seat 1 naturally swiveling while traveling along a curved rail.

In addition, as shown in FIGS. 11A and 11B, the control part 60 may be installed on the vehicle seat 1 being transported along a closed curved long slide L2 to rotate the rotor 12 in a direction that compensates for the rotation angle of the vehicle seat 1 naturally swiveling while traveling along the curved rail.

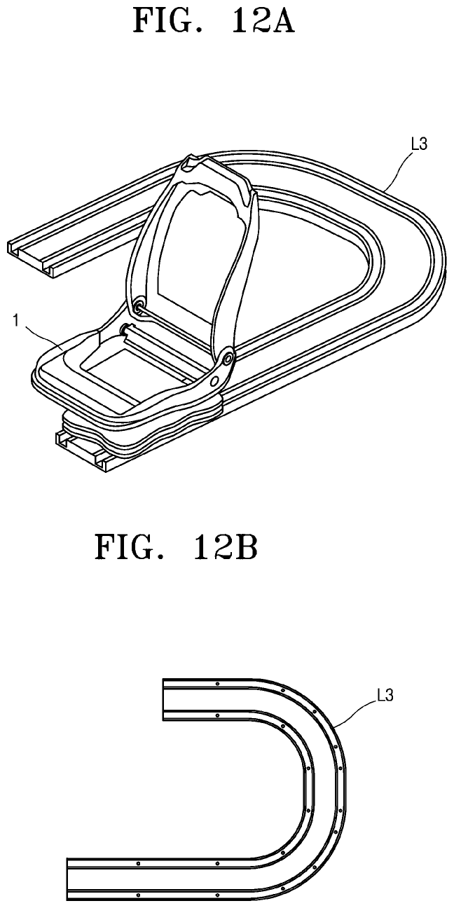

In addition, as shown in FIGS. 12A and 12B, the control part 60 may be installed on the vehicle seat 1 being transported along a U-shaped long slide L3 to rotate the rotor 12 in a direction that compensates for the rotation angle of the vehicle seat 1 naturally swiveling while traveling along the curved rail.

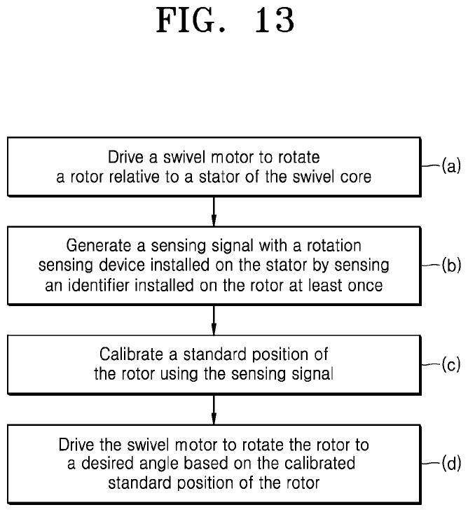

FIG. 13 is a flowchart showing a rotation angle sensing method of the swivel core according to some embodiments of the present disclosure.

The rotation angle sensing method of the swivel core according to some embodiments of the present disclosure, as shown in FIGS. 1 to 13, may include a step (a) driving the swivel motor M to rotate the rotor 12 relative to the stator 11 of the swivel core 10, a step (b) generating the sensing signal with the rotation sensing device 20 installed on the stator 11 by sensing the identifier 30 installed on the rotor 12 at least once, a step (c) calibrating the standard position of the rotor 12 using the sensing signal, and a step (d) driving the swivel motor M to rotate the rotor 12 to a desired angle based on the calibrated standard position of the rotor 12.

Here, in step (c), the standard position may be calculated by counting the hall IC signals using the hall IC signal counter part C of the swivel motor M.

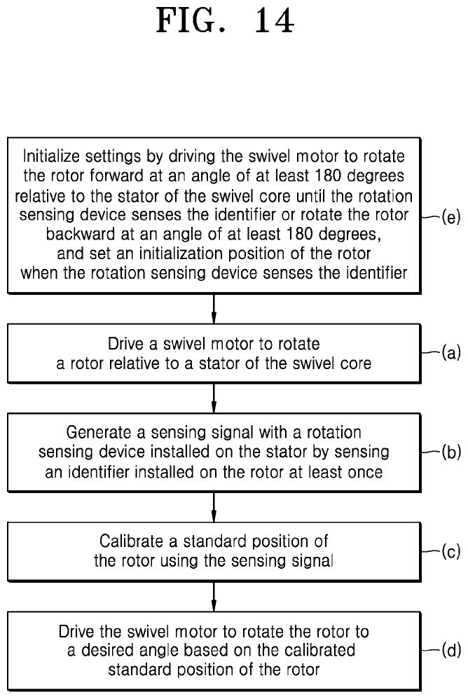

FIG. 14 is a flowchart illustrating a rotation angle sensing method of the swivel core according to some other embodiments of the present disclosure.

The rotation angle sensing method of the swivel core according to some embodiments of the present disclosure, as shown in FIGS. 1 to 14, may include a step (e) initializing the settings by driving the swivel motor M to rotate the rotor 12 forward at an angle of at least 180 degrees relative to the stator 11 of swivel core 10 until the rotation sensing device 20 senses the identifier 30 or rotate the rotor 12 backward at an angle of at least 180 degrees, and setting the initialization position of the rotor 12 when the rotation sensing device 20 senses the identifier 30, a step (a) driving the swivel motor M to rotate the rotor 12 relative to the stator 11 of the swivel core 10, a step (b) generating the sensing signal with the rotation sensing device 20 installed on the stator 11 by sensing the identifier 30 installed on the rotor 12 at least once, a step (c) calibrating the standard position of the rotor 12 using the sensing signal, and a step (d) driving the swivel motor M to rotate the rotor 12 to a desired angle based on the calibrated standard position of the rotor 12.

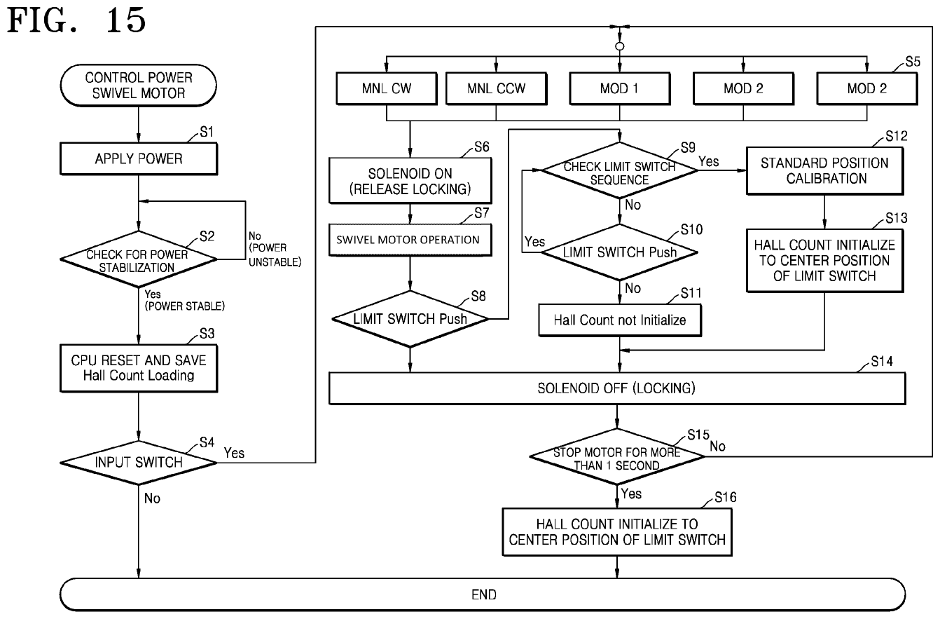

FIG. 15 is a flowchart illustrating a rotation angle sensing method of the swivel core in accordance with some other embodiments of the present disclosure.

As shown in FIG. 15, the rotation angle sensing method of the swivel core according to some other embodiments of the present disclosure may include applying power to start controlling the power swivel motor (S1), checking for power stabilization (S2), and if there is no abnormality, resetting the central processing unit (CPU) to reload the hall counting numbers (S3).

Then, when a switch is input (S4), it is determined that the input switch is a manual clockwise (CW) operation switch, a manual counterclockwise (CCW) operation switch, a first mode operation switch, a second mode operation switch, a third mode operation switch, or the like (S5), the solenoid locking device (50, see FIG. 2) is turned off (ON) (S6), and the swivel motor (M, see FIG. 9) is operated in an operation corresponding to the switch (S7).

At this time, if the contact sensor (21, see FIGS. 7 and 8) is pushed by the hill part 31 (LIMIT SWITCH Push, S8), it calibrates the standard position of rotor 12 (S12) according to the limit switch sequence (S9), may reset the hall counting numbers to the center position (highest point P2, etc.) of the limit sensor (S13), or otherwise not reset the hall counting numbers (S11) even if the limit sensor is pushed (S10).

Then, when the standard position of the rotor 12 is correctly recognized according to the limit switch sequence, the rotation of the swivel motor M may be constrained by locking (OFF) the solenoid locking device 50 (S14).

At this time, the swivel motor M can be stopped for more than 1 second (S15), and the hall counting numbers may be reset to the center position (highest point P2, etc.) of the limit sensor.

The present disclosure has been described with reference to the embodiments illustrated in the drawings, but these embodiments are merely illustrative and it should be understood by a person with ordinary skill in the art that various modifications and equivalent embodiments can be made without departing from the scope of the present disclosure. Therefore, the true technical protective scope of the present disclosure must be determined based on the technical concept of the appended claims.

### REFERENCE SIGNS LIST

10: Swivel core
11: Stator
12: Rotor
20: Rotation sensing device
21: Contact sensor
211: Switch body
212: Button part
213: Switch circuit part
30: Identifier
31: Hill part
31a: Uphill portion
31b: Downhill portion
P1: Starting point
P2: Highest point
P3: End point
K: Identification angle
40: Fixing bracket
50: Solenoid locking device
51: Locking protrusion
G: Inner groove
60: Control part
M: Swivel motor
L1: S-shaped long slide
L2: Closed curved long slide
L3: U-shaped long slide
1: Vehicle seat
C: Hall IC signal counter part
100: Rotation angle sensing system of the swivel core

What is claimed is:

1. A rotation angle sensing system of a swivel core comprising:
a rotation sensing device installed on a stator of the swivel core and sensing rotation state of a rotor of the swivel core; and
an identifier formed on the rotor to generate a sensing signal of the rotation sensing device.

2. The rotation angle sensing system of the swivel core of claim 1,
wherein the rotation sensing device is a contact sensor sensing contact with the identifier,
and the identifier is a hill part formed to protrude from an inner surface of the rotor.

3. The rotation angle sensing system of the swivel core of claim 1,
wherein the contact sensor comprises,
a switch body;
a button part installed to be able to move forward and backward in the direction from the switch body to the identifier; and
a switch circuit part installed at the switch body and generating an ON signal when the button part is pressed by the identifier.

4. The rotation angle sensing system of the swivel core of claim 3,
wherein the hill part comprises,
an uphill portion formed from a starting point, where contact with the button part begins, to a highest point; and
a downhill portion formed from the highest point to an end point, where contact with the button part ends.

5. The rotation angle sensing system of the swivel core of claim 4,
wherein a contact slope of the uphill portion and the downhill portion is a gently curved surface.

6. The rotation angle sensing system of the swivel core of claim 1, further comprising:
a fixing bracket which is fixed to one side of the stator and where the rotation sensing device is installed;
a solenoid locking device installed at the fixing bracket to enable accurate locking by the sensing signal of the rotation sensing device and moving forward a locking protrusion to be combined with an inner groove formed at the rotor when the rotor is locking; and
a control part receiving the sensing signal from the rotation sensing device, calibrating a standard position by using the sensing signal, transmitting a motor control signal driving a swivel motor to rotate the rotor of the swivel core based on the standard position, and transmitting a locking control signal to the solenoid locking device before or after applying the motor control signal.

7. The rotation angle sensing system of the swivel core of claim 6,
wherein the control part is installed on any of a vehicle seat being transported along a S-shaped long slide, a vehicle seat being transported along a closed curved long slide, and a vehicle seat being transported along a U-shaped long slide to rotate the rotor in a direction that compensates for the rotation angle of the vehicle seat naturally swiveling while traveling along a curved rail.

8. A rotation angle sensing method of a swivel core comprising:
a step (a) driving a swivel motor to rotate a rotor relative to a stator of a swivel core;
a step (b) generating a sensing signal with a rotation sensing device installed on the stator by sensing an identifier installed on the rotor at least once;
a step (c) calibrating a standard position of the rotor using the sensing signal; and
a step (d) driving the swivel motor to rotate the rotor to a desired angle based on the calibrated standard position of the rotor.

9. The rotation angle sensing method of the swivel core of claim 8,
wherein in the step (c), the standard position is calculated by counting hall IC signals of the swivel motor.

10. The rotation angle sensing method of the swivel core of claim 8, further comprising prior to the step (a),
a step (e) initializing settings by driving the swivel motor to rotate the rotor forward at an angle of at least 180 degrees relative to the stator of the swivel core until the rotation sensing device senses the identifier or rotate the rotor backward at an angle of at least 180 degrees, and setting an initialization position of the rotor when the rotation sensing device senses the identifier.
